(19) United States
(12) Patent Application Publication
(10) Pub. No.: US 2026/0025651 A1
(43) Pub. Date: Jan. 22, 2026

(54) CROSS-LINK POWER SAVE STATE AND POWER MANAGEMENT MODE INDICATION

(71) Applicant: Samsung Electronics Co., Ltd., Suwon-si (KR)

(72) Inventors: Vishnu Vardhan Ratnam, Plano, TX (US); Boon Loong Ng, Plano, TX (US); Rubayet Shafin, Allen, TX (US); Peshal Nayak, Plano, TX (US); Yue Qi, Plano, TX (US); Bilal Sadiq, Frisco, TX (US)

(21) Appl. No.: 19/227,381

(22) Filed: Jun. 3, 2025

Related U.S. Application Data
(60) Provisional application No. 63/672,522, filed on Jul. 17, 2024.

(51) Int. Cl. H04W 8/22; H04W 52/02; H04W 56/00

(52) U.S. Cl. CPC H04W 8/22; H04W 52/0274; H04W 56/0015

(57) ABSTRACT

A method and device for enhancing cross-link power save state and power management mode indication. A method for operating a non-AP MLD, the non-AP MLD including STAs, each STA configured to transmit and receive information on a respective link established with a corresponding AP of an AP MLD. The method includes: determining a capability to transmit power management mode change signaling or power save state change signaling for a first STA of the non-AP MLD; generating a first message including an indication that indicates the capability to transmit power management mode change signaling or power save state change signaling for the first STA; and transmitting the first message including the indication that indicates the capability to transmit power management mode change signaling or power save state change signaling for the first STA to the AP MLD.

### CROSS-REFERENCE TO RELATED APPLICATION(S) AND CLAIM OF PRIORITY

This application claims priority under 35 U.S.C. § 119(e) to U.S. Provisional Patent Application No. 63/672,522 filed on Jul. 17, 2024, which is hereby incorporated by reference in its entirety.

### TECHNICAL FIELD

This disclosure relates generally to wireless communication, and more specifically to enhancing cross-link power save state and power management mode indication.

### BACKGROUND

Wireless Local Area Network (WLAN) technology allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for enhancing cross-link power save state and power management mode indication.

In one embodiment, a non-access point multi-link device (non-AP MLD), comprises: stations (STAs), each STA comprising a transceiver configured to transmit and receive information on a respective link established with a corresponding access point (AP) of an access point multi-link device (AP MLD). The non-AP MLD further comprises a processor operably coupled with the STAs. The processor is configured to: determine a capability to transmit power management mode change signaling or power save state change signaling for a first STA of the non-AP MLD; generate a first message including an indication that indicates the capability to transmit power management mode change signaling or power save state change signaling for the first STA; and transmit, via a first transceiver of the first STA, the first message including the indication that indicates the capability to transmit power management mode change signaling or power save state change signaling for the first STA to the AP MLD.

In another embodiment, AP-MLD comprises: APs, each AP comprising a transceiver configured to transmit and receive information on a respective link established with a corresponding STA of a non-AP MLD. The AP-MLD further comprises a processor operably coupled with the APs. The processor is configured to: determine a capability to transmit power management mode change signaling or power save state change signaling for a first AP of the AP MLD; generate a first message including an indication that indicates the capability to transmit power management mode change signaling or power save state change signaling for the first AP; and transmit, via a first transceiver of the first AP, the first message including the indication that indicates the capability to transmit power management mode change signaling or power save state change signaling for the first AP to the non-AP MLD.

In yet another embodiment, a method for operating a non-AP MLD is provided. The non-AP MLD comprises STAs, each STA configured to transmit and receive information on a respective link established with a corresponding AP of an AP MLD. The method comprises: determining a capability to transmit power management mode change signaling or power save state change signaling for a first STA of the non-AP MLD; generating a first message including an indication that indicates the capability to transmit power management mode change signaling or power save state change signaling for the first STA; and transmitting the first message including the indication that indicates the capability to transmit power management mode change signaling or power save state change signaling for the first STA to the AP MLD.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example access point (AP) according to embodiments of the present disclosure;

FIG. 3 illustrates an example station (STA) according to embodiments of the present disclosure;

FIG. 4 illustrates an example flow diagram of an operation performed by a receiving STA for transmission of cross-link power management mode transition or cross-link power save state transition according to embodiments of the present disclosure;

FIG. 5 illustrates an example flow diagram of an operation performed by a transmitting STA for transmission of cross-link power management mode transition or cross-link power save state transition according to embodiments of the present disclosure; and

FIG. 6 illustrates an example method performed by a non-AP MLD in a wireless communication system according to embodiments of the present disclosure.

### DETAILED DESCRIPTION

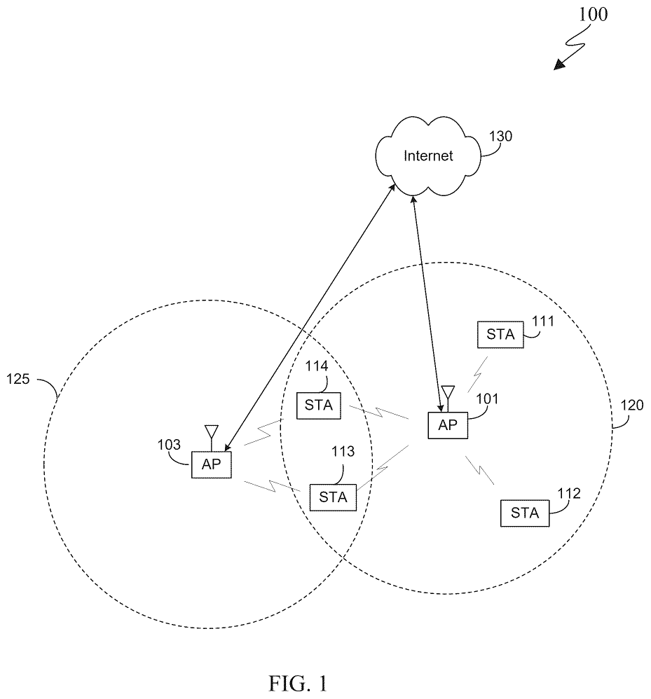

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein:
[1] IEEE 802.11-2020, “Wireless LAN Medium Access Control (MAC) and Physical Layer (PHY) Specification”; [2] IEEE 802.11ax/D8.0; [3] IEEE P802.11be/D5.0; [4]U.S. Publication Number 2024/0205825.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP”, such as “router” or “gateway”. For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA”, such as “mobile station”, “subscriber station”, “remote terminal”, “user equipment”, “wireless terminal”, or “user device”. For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the APs may include circuitry and/or programming for facilitating enhancing cross-link power save state and power management mode indication. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

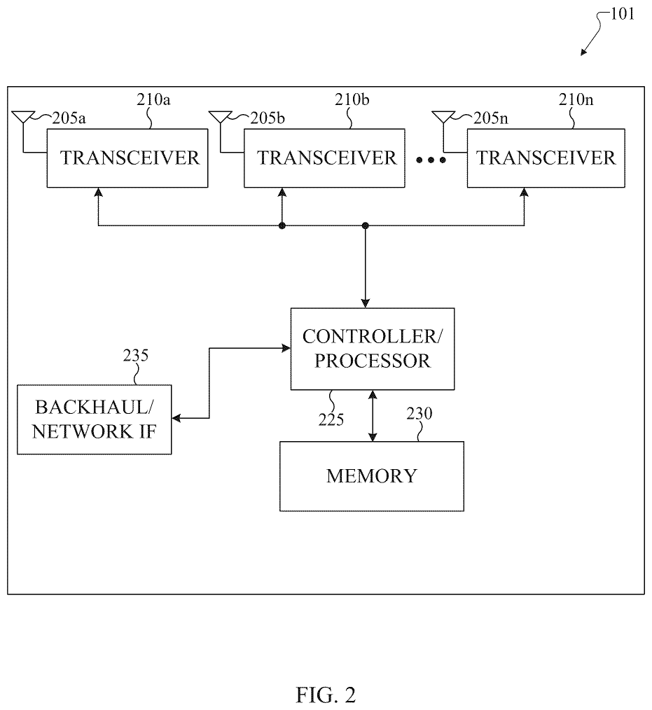

FIG. 2 illustrates an example AP 101 according to various embodiments of the present disclosure. The embodiment of the AP 101 illustrated in FIG. 2 is for illustration only, and the AP 103 of FIG. 1 could have the same or similar configuration. In some embodiments discussed herein, the AP 101 can be an AP MLD. However, APs come in a wide variety of configurations, and FIG. 2 does not limit the scope of this disclosure to any particular implementation of an AP.

The AP 101 includes multiple antennas 205a-205n and multiple transceivers 210a-210n. The AP 101 also includes a controller/processor 225, a memory 230, and a backhaul or network interface 235. The transceivers 210a-210n receive, from the antennas 205a-205n, incoming radio frequency (RF) signals, such as signals transmitted by STAs 111-114 in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the AP 101. For example, the controller/processor 225 could control the reception of forward channel signals and the transmission of reverse channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing signals from multiple antennas 205a-205n are weighted differently to effectively steer the outgoing signals in a desired direction. The controller/processor 225 could also support OFDMA operations in which outgoing signals are assigned to different subsets of subcarriers for different recipients (e.g., different STAs 111-114). Any of a wide variety of other functions could be supported in the AP 101 by the controller/processor 225 including facilitating enhancing cross-link power save state and power management mode indication. In some embodiments, the controller/processor 225 includes at least one microprocessor or microcontroller. The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the AP 101 to communicate with other devices or systems over a backhaul connection or over a network. The interface 235 could support communications over any suitable wired or wireless connection(s). For example, the interface 235 could allow the AP 101 to communicate over a wired or wireless local area network or over a wired or wireless connection to a larger network (such as the Internet). The interface 235 includes any suitable structure supporting communications over a wired or wireless connection, such as an Ethernet or RF transceiver. The memory 230 is coupled to the controller/processor 225. Part of the memory 230 could include a RAM, and another part of the memory 230 could include a Flash memory or other ROM.

As described in more detail below, the AP 101 may include circuitry and/or programming for facilitating enhancing cross-link power save state and power management mode indication. Although FIG. 2 illustrates one example of AP 101, various changes may be made to FIG. 2. For example, the AP 101 could include any number of each component shown in FIG. 2. As a particular example, an access point could include a number of interfaces 235, and the controller/processor 225 could support routing functions to route data between different network addresses. Alternatively, only one antenna and transceiver path may be included, such as in legacy APs. Also, various components in FIG. 2 could be combined, further subdivided, or omitted and additional components could be added according to particular needs.

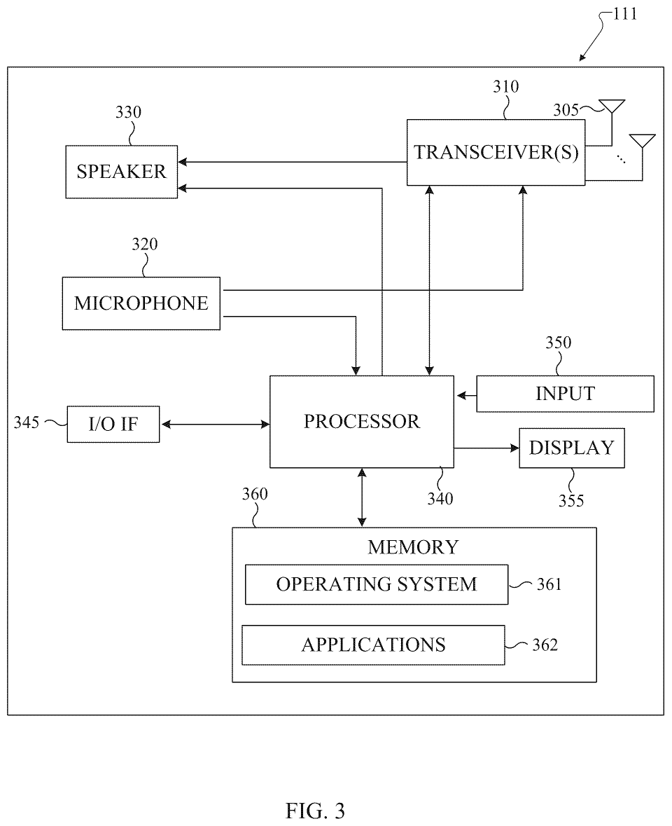

FIG. 3 illustrates an example STA 111 according to various embodiments of the present disclosure. The embodiment of the STA 111 illustrated in FIG. 3 is for illustration only, and the STAs 111-114 of FIG. 1 could have the same or similar configuration. In some embodiments discussed herein, the STA 111 can be a non-AP MLD. However, STAs come in a wide variety of configurations, and FIG. 3 does not limit the scope of this disclosure to any particular implementation of a STA.

The STA 111 includes antenna(s) 305, transceiver(s) 310, a microphone 320, a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna(s) 305, an incoming RF signal (e.g., transmitted by an AP 101 of the network 100). The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors and execute the basic OS program 361 stored in the memory 360 in order to control the overall operation of the STA 111. In one such operation, the processor 340 controls the reception of forward channel signals and the transmission of reverse channel signals by the transceiver(s) 310 in accordance with well-known principles. The processor 340 can also include processing circuitry configured to facilitate enhancing cross-link power save state and power management mode indication. In some embodiments, the processor 340 includes at least one microprocessor or microcontroller.

The processor 340 is also capable of executing other processes and programs resident in the memory 360, such as operations for facilitating enhancing cross-link power save state and power management mode indication. The processor 340 can move data into or out of the memory 360 as required by an executing process. In some embodiments, the processor 340 is configured to execute a plurality of applications 362, such as applications for facilitating enhancing cross-link power save state and power management mode indication. The processor 340 can operate the plurality of applications 362 based on the OS program 361 or in response to a signal received from an AP. The processor 340 is also coupled to the I/O interface 345, which provides STA 111 with the ability to connect to other devices such as laptop computers and handheld computers. The I/O interface 345 is the communication path between these accessories and the processor 340.

The processor 340 is also coupled to the input 350, which includes for example, a touchscreen, keypad, etc., and the display 355. The operator of the STA 111 can use the input 350 to enter data into the STA 111. The display 355 may be a liquid crystal display, light emitting diode display, or other display capable of rendering text and/or at least limited graphics, such as from web sites. The memory 360 is coupled to the processor 340. Part of the memory 360 could include a random-access memory (RAM), and another part of the memory 360 could include a Flash memory or other read-only memory (ROM).

Although FIG. 3 illustrates one example of STA 111, various changes may be made to FIG. 3. For example, various components in FIG. 3 could be combined, further subdivided, or omitted and additional components could be added according to particular needs. In particular examples, the STA 111 may include any number of antenna(s) 305 for MIMO communication with an AP 101. In another example, the STA 111 may not include voice communication or the processor 340 could be divided into multiple processors, such as one or more central processing units (CPUs) and one or more graphics processing units (GPUs). Also, while FIG. 3 illustrates the STA 111 configured as a mobile telephone or smartphone, STAs could be configured to operate as other types of mobile or stationary devices.

Embodiments of the present disclosure recognize that although cross-link power management mode and power save state signaling are described in the literature, several issues are yet unresolved. For example, there may be limitations at the AP MLD, on the transfer of power save (PS) and power management (PM) states across the links. Such limitations should be indicated to a non-AP MLD that intends to use cross-link signaling. Similarly, how to include the cross-link signaling in control frames like PS-poll frames needs further discussion. Finally, there may be RACE conditions wherein, two different power management or power save state indications for a STA can be scheduled for indication at different times, but may be delivered out of order due to channel contention delay. This may cause incorrect communication of the current power save state or power management mode of the STA to the AP which may need resolution.

Accordingly, embodiments of the present disclosure provide mechanisms for improving cross-link power management mode and power save state indication.

IEEE 802.11be [3] supports multiple bands of operation, where an access point (AP) and a non-AP device can communicate with each other, called links. Thus, both the AP and non-AP device may be capable of communicating on different bands/links, which is referred to as multi-link operation (MLO). Devices capable of such MLO are referred to as multi-link devices (MLDs). Upon associating with an AP MLD on a set of links (called setup links), each such non-AP device is assigned a unique association identifier (AID).

An MLD may also serve several different types of traffic categories having a different requirement on throughput, latency etc. To enable traffic differentiation each traffic category can be assigned a traffic identifier (TID). For prioritization of channel access to different TIDs on the different links, and to limit contention, the AP MLD and non-AP MLD may also negotiate a TID-to-link mapping for such MLO. Such a TID-to-link mapping would identify, for each link, which TIDs are eligible for transmission/reception. Note that the default TID-to-link mapping allows any TID to be transmitted on any link.

In normal mode of operation, called active mode, a STA is always in ‘awake’ state, i.e., it continuously monitors the channel and can transmit and receive packets. To allow non-AP devices to save power, the spec [1-3] also supports several power save options, that enable a STA to operate and switch in two possible states: ‘awake’ and ‘doze’. In the ‘awake’ state, a STA of a non-AP MLD can continuously monitor the channel and transmit and receive packets, but in doze state, it is not expected to be able to transmit and receive packets. Several such power save mechanisms have been defined in [1] such as Normal power save (PS) mode, automatic power save delivery (APSD), wireless network management (WNM) power save mode, Power-save multi-poll mode, Spatial multiplexing PS, IBSS power save, VHT TXOP Power Save etc. In the PS mechanism, to indicate to the AP MLD that a STA is changing its power management mode from active mode to power save mode, a STA may transmit a PPDU with the power management (PM) bit in the frame control field set to 1. Similarly, when a STA intends to change its power management mode from power save mode to active mode, it may send a PPDU to the AP with which it is affiliated with the PM bit in the frame control field set to 0.

When a STA is in PM mode and its state is doze state, the corresponding AP of the AP MLD buffers “buffer-able packets” that are addressed to the STA and that can't be delivered to another STA associated with the same device in active state. Such buffered packets are called buffered units (BUs), and are delivered when the STA returns to awake state. To indicate to all the associated non-AP devices about such pending BUs via a broadcast or multi-cast signaling, each AP of the AP MLD periodically includes a traffic information map (TIM) element and, optionally, also a multi-link traffic indication element, within the beacon frames it transmits. Each AP of the AP MLD may also additionally transmit these elements as a separate periodic broadcast TIM frame.

Listening to the TIM element and/or multi-link traffic indication element in such a beacon frame, the non-AP device may know about pending traffic buffered at the AP. To indicate to an AP that it is in active state and ready to receive data, a STA affiliated with a non-AP device may transmit a PS poll, U-APSD trigger frame etc. Note that such an indication may not be required for a STA to send a packet in the uplink direction. When an AP affiliated with an AP MLD receives a PS-Poll frame or a U-APSD trigger frame from a STA affiliated with an associated non-AP MLD that is in power save mode, it can transmit buffered BU(s) to the STA, if one is available and not discarded for implementation dependent reasons, otherwise it may transmit a QoS Null frame. After initiating a frame exchange sequence with a STA of a non-AP MLD that is in power save mode to transmit BUs, the affiliated AP uses the More Data subfield in the Frame Control field of a transmitted data frame to indicate to a non-AP STA whether more individually addressed BUs are buffered for that non-AP MLD. The indicated buffered BUs (not including the BU currently being transmitted) are buffered at the AP MLD for the non-AP MLD and correspond to Data frames with TIDs that are mapped to this link or Management frames that are not a TPC Request frame or a Link Measurement Request frame. If no such frames are pending, i.e., if the More Data subfield is set to 0, then the STA of the non-AP MLD can go back to doze state after the end of the frame exchange sequence. If the STA is in U-APSD power save mode, the AP may set the EOSP subfield of the QoS Control field of a transmitted frame to 1 to indicate that the STA may transition back to doze state.

A STA that is in doze state may not be able to sense the channel and correspondingly it may not be aware of the current state of the channel or when existing transmissions (if any) will end, which is referred to as loss of medium synchronization. So, if it transmits immediately, it can cause collisions with existing transmissions. Correspondingly, the STA that is changing from doze to awake state to transmit can perform clear channel assessment (CCA) procedure until a frame is detected by which it can set its network allocation vector (NAV) timer, or until a period of time indicated by the NAVSyncDelay has transpired since the CCA has begun. After that it may transmit a packet.

In the baseline spec [1-3] the PM indication and PS state indication are per-link indications that are indicated separately for each link in MLO operation. In [4], methods for a STA of a non-AP MLD to indicate to the AP MLD, the change of the power-save state or the power management mode of another STA affiliated with the same non-AP MLD are described. This can significantly reduce the overhead of signaling, can reduce the latency of signaling, and is beneficial in scenarios where there is significant disparity in the different link capabilities and parameters (such as when millimeter-wave links are introduced into MLO framework).

Although cross-link power management mode and power save state signaling are described in [4], several issues are yet unresolved. For example, there may be limitations at the AP MLD, on the transfer of PS and PM states across the links. Such limitations should be indicated to a non-AP MLD that intends to use cross-link signaling. Similarly, how to include the cross-link signaling in control frames like PS-poll frames needs further discussion. Finally, there may be RACE conditions wherein, two different power management or power save state indications for a STA can be scheduled for indication at different times, but may be delivered out of order due to channel contention delay. This may cause incorrect communication of the current power save state or power management mode of the STA to the AP which may need resolution. This disclosure details methods for improving cross-link power management mode and power save state indication by including solutions to the aforementioned issues, among others.

Without loss of generality, in the present disclosure, the cross-link indication of power management mode is referred to as multi-link power management (MLPM) and the cross-link indication of power save state is referred to as multi-link power-save state (MLPS) indication. This is only for ease of explanation and shall not be construed as a limitation of the disclosure.

### MLPM Parameter Indication:

An AP MLD may carry an indication of one or more of:
MLPM support: In some embodiments, it may be mandatory for AP MLDs beyond a certain WiFi generation, e.g., 802.11bn, to support cross-link power management mode indication, i.e., receiving a power management mode switch indication for a STA affiliated with a non-AP MLD via a frame transmitted by another STA affiliated with the same non-AP MLD. In another embodiment, the support may be optional and may be indicated by the AP MLD in its Capabilities element. For example, this can be carried in an MLPM Support subfield. In one variant, the support indication can be common to all STAs affiliated with an AP MLD. In another variant, the support indication can be separate for each STA affiliated with the AP MLD. This can be carried for example, by using separate MLPM Support subfields for each link in the Per-STA Profile sub-element of the Basic Multi-link element, or it can be carried using a single MLPM Support Link Bitmap field, where each bit in the bitmap indicates the support status for a link.
Links for which cross-link signaling is applicable: In some embodiments, any AP that indicates capability of MLPM Support is expected to be capable of receiving cross-link signaling for any other AP affiliated with the same AP MLD. In another embodiment, any AP that indicates capability of MLPM Support is expected to be capable of receiving cross-link signaling for any other AP affiliated with the same AP MLD, if the other AP also supports MLPM. In yet another embodiment, there may be a restriction on the links for which an AP STA is capable of receiving cross-link indication. For example, if AP1, AP2 and AP3 are affiliated with the same AP MLD, it is possible that AP1 is capable of receiving cross-link power management mode indication for AP2 and AP2 is capable of receiving cross-link power management mode indication for AP3. Thus, in this embodiment, along with an indication of the MLPM Support, there can be an additional bitmap for each link the other links for which it is capable of receiving the cross-link MLPM indication. In the above example, in the bitmap corresponding to AP1, the bit for AP2 may be set to 1 and to AP3 may be set to 0.
MLPM Delay: In some embodiments, the AP MLD may indicate the amount of time it needs to process and successfully apply an indication of cross-link power management mode indication received at a first AP of the AP MLD which is applicable for a STA associated with another AP of the same AP MLD, called the MLPM Delay. In some embodiments this MLPM Delay can be a predefined amount of time defined by the standard that any AP MLD with MLPM Support should comply with. In another embodiment, the time duration can be different for each AP affiliated with an AP MLD. The information can be carried, for example in a MLPM Delay subfield of the Common Info field or the Per-STA Profile sub-element of the Basic Multi-link element transmitted by the AP MLD.
MLPM Capability: In some embodiments, STAs of an MLD may also indicate whether they are capable of sending cross-link indication of power management mode change. This capability indication can be called MLPM Capability indication and can have similar variants as described above for MLPM Support.
MLPM TSF Link ID: An indication of the link identifier of the link whose time synchronization function (TSF) value should be used in the MLPM indications.

In some embodiments, the aforementioned indications can be reserved for a non-AP MLD. In another variant, a non-AP MLD may also use the aforementioned fields to indicate to a peer MLD the links for which they can receive cross-link power management indication. MLPS parameter indication:

An AP MLD may carry an indication of one or more of:
MLPS Support: In some embodiments, it may be mandatory for AP MLDs beyond a certain WiFi generation, e.g., 802.11bn, to support cross-link power save state indication, i.e., receiving an indication of doze→awake state transition for a STA affiliated with a non-AP MLD via a frame transmitted by another STA affiliated with the same non-AP MLD. This frame can be, for example, a PS-poll frame, an unscheduled automatic power save delivery (U-APSD) trigger frame, etc. In another embodiment, the support may be optional and may be indicated by the AP MLD in its Capabilities element. In one variant, the support indication can be common to all STAs affiliated with an AP MLD. In another variant, the support indication can be separate for each STA affiliated with the AP MLD. This can be carried for example, by using separate support bits for each link in the Per-STA Profile sub-element of the Basic Multi-link element, or it can be carried using a Link Bitmap field, where each bit in the bitmap indicates the support status for a link.
Links for which cross-link signaling is applicable: In some embodiments, any AP that indicates capability of MLPS Support is expected to be capable of receiving cross-link signaling for any other AP affiliated with the same AP MLD. In another embodiment, any AP that indicates capability of MLPS Support is expected to be capable of receiving cross-link signaling for any other AP affiliated with the same AP MLD, if the other AP also supports MLPS. In yet another embodiment, there may be a restriction on the links for which an AP STA is capable of receiving cross-link indication. For example, if AP1, AP2 and AP3 are affiliated with the same AP MLD, it is possible that AP1 is capable of receiving cross-link power save state indication for AP2, and AP2 is capable of receiving cross-link power-save state indication for AP3. Thus, in this embodiment, along with an indication of the MLPS Support, there can be an additional bitmap for each link the other links for which it is capable of receiving the cross-link MLPS indication. In the above example, in the bitmap corresponding to AP1, the bit for AP2 may be set to 1 and to AP3 may be set to 0.
MLPS Delay: In some embodiments, the AP MLD may indicate the amount of time it needs to process and successfully apply an indication of cross-link power save state indication received at a first AP of the AP MLD which is applicable for a STA associated with another AP of the same AP MLD, called the MLPS Delay. In some embodiments this MLPS Delay can be a predefined amount of time defined by the standard that any AP MLD with MLPS Support should comply with. In another embodiment, the time duration can be different for each AP affiliated with an AP MLD. The information can be carried, for example in a MLPS Delay subfield of the Common Info field or the Per-STA Profile sub-element of the Basic Multi-link element transmitted by the AP MLD.
MLPS Capability: In some embodiments, STAs of an MLD may also indicate whether they are capable of sending cross-link indication of power-save state change. This capability indication can be called MLPS Capability indication and can have similar variants as described above for MLPS Support.
MLPS TSF Link ID: An indication of the link identifier of the link whose time synchronization function (TSF) value should be used in the MLPS indications.

In some embodiments, the aforementioned indications can be reserved for a non-AP MLD. In another variant, a non-AP MLD may also use the aforementioned fields to indicate to a peer MLD the links for which they can receive cross-link power-save state indication.

### Common Parameter Indication:

In some embodiments, there can be a single indication of supporting cross-link power management mode and cross-link power save state indication, i.e., either both are supporter, or neither are supported. This common indication can be called, for example, Multi-link Power Management and Power-save State (MLPMPS) indication. Although, in the rest of the disclosure, embodiments may discuss separately about MLPM and MLPS based indications, it should be understood that a common indication is also possible for both features together.

### MLPM Indication:

To provide cross-link indication of a change in power management mode, a STA affiliated with an MLD may transmit a frame to a peer MLD that may include an indication of one or more of:
PM subtype: This is an indication that the signaling in the frame is for indicating change in power management mode.
PM mode: This is an indication of the applicable power management mode for one or more links. In one example, this can be a 1-bit field with encoding similar to the legacy PM bit [1], that indicates a common PM mode for one or more links. In another example, the indication can be different for each link and so it can be carried in a bitmap field where each bit in the bitmap indicates the PM mode for one STA affiliated with the transmitting MLD.
Applicable links: This can be an indication of the links for which the PM mode indication mentioned above is applicable. In one example, there can be a link ID field indicating the link for which the signaling is applicable. In another example, there can be a link Bitmap field, where each bit indicates whether the PM mode indication is applicable to a particular STA affiliated with the transmitting MLD.
Applicable start time: This can be an indication of the time when the indicated PM change should be applied. The indication can be an indication of the TSF when the change is applicable. The TSF can be, for example, corresponding to the link where the signaling is indicated. If the indication is for a single link, then the TSF can also be based on the link where the signaling is applicable. Especially for cross-link signaling of change of PM mode from 0 to 1, it may be ensured that there is sufficient time for the peer STA to transfer the information across the links (i.e., MLPM Delay), before the start time of the PM change.
Applicable duration: This can be an indication of the duration for which the PM change should be applied, counting from the indicated start time. After the indicated duration expires, the PM mode may toggle back to the opposite PM mode. Especially for cross-link signaling of change of PM mode from 1 to 0, it may be ensured that there is sufficient time for the peer STA to transfer the information across the links (i.e., MLPM Delay), before the toggle back time of the PM from 0 to 1.
Sequence number: This can be a field indicating the count order of the PM changes. With each PM change indication generated, the sequence number may be incremented by 1. In some embodiments, the sequence number can be maintained separately for each STA of the transmitting MLD and can be incremented whenever an MLPM or PM bit indication is generated for that STA. In another embodiment, the sequence number can be a global count that is common for all STAs of the transmitting MLD and can be incremented when MLPM or PM bit indication is generated for any affiliated STA. The use of this field can be, for example, to deal with reception of duplicate frames indicating PM changes or out-of-order delivery of PM change indications. For example, when a recipient MLD receives a cross-link PM indication for a STA1 affiliated with a transmitting MLD, the same PM mode shall be applied to STA1 if the sequence number is higher than the sequence number received previously for STA1. When the sequence numbers become large, appropriate changes in rules may be used to deal with wrap-around of the counter.
TSF indication: This can be a field indicating the time at which the transmitting MLD generated the cross-link MLPM indication. The value can be in-terms of the TSF clock of the link where the frame is transmitted or can be based on the TSF clock of a reference link that is predetermined. The use of this field can be, for example, to deal with duplicate and out-of-order delivery of cross-link indications. In some embodiments, a subset of the bits of the TSF count are indicated.

In one example embodiment the above information can be carried in a new A-control field included by the transmitting MLD in a QoS frame. In the case where the transmitted frame is a control frame is a PS-poll frame, the frame can be included in a control-wrapper so that it can include an A-control field. In another example, the above indications can be carried in a new Action frame. For convenience, such a frame is referred to herein as a MLPM Notification frame.

In some variants, the PM bit information in the MAC header of the MLPM Notification frame can be combined with the information in the body of the MLPM Notification frame to reduce the number of signaling bits required for indicating the PM Mode and the corresponding applicable links. The corresponding compression rules can be as in [4].

### MLPS Indication:

To provide cross-link indication of a change in power-save state, a STA affiliated with an MLD may transmit a frame to a peer MLD that may include an indication of one or more of:
PS subtype: This is an indication that the signaling in the frame is for indicating change in power-save state.
PS state: This is an indication of the applicable power state transitions for one or more links. In one example, this can be a 1-bit field which is set to 1 to indicate a transition from doze→awake state for one or more links, and is set to 0 otherwise. In another example, the indication can be different for each link and so it can be carried in a bitmap field where each bit in the bitmap indicates the doze→awake state transition for one STA affiliated with the transmitting MLD.
Applicable links: This can be an indication of the links for which the PS State indication mentioned above is applicable. In one example, there can be a link ID field indicating the link for which the signaling is applicable. In another example, there can be a link Bitmap field, where each bit indicates whether or not the doze→awake state indication is applicable to a particular STA affiliated with the transmitting MLD.
Applicable start time: This can be an indication of the time when the indicated PS state change should be applied. The indication can be an indication of the TSF when the change is applicable. The TSF can, for example, be corresponding to the link where the signaling is indicated. If the indication is for a single link, then the TSF can also be based on the link where the signaling is applicable.
Applicable duration: This can be an indication of the duration for which the awake state is applicable, counting from the indicated start time. After the indicated duration expires the PS state may toggle back to doze state. In another example this toggle back may not be performed by the STA if within this duration a frame is received from the peer MLD, and the last such frame has More Data field set to 1. It may be ensured that there is sufficient time for the peer STA to transfer the information across the links (i.e., MLPS Delay), before the toggle back time of the transition from awake to doze state.
Sequence number: This can be a field indicating the count order of the PS state changes. With each PS state change (from doze to awake) indication generated, the sequence number may be incremented by 1. In some embodiments, the sequence number can be maintained separately for each STA of the transmitting MLD and can be incremented whenever an MLPS indication is generated for that STA. In another embodiment, the sequence number can be a global count that is common for all STAs of the transmitting MLD and can be incremented when MLPS indication is generated for any affiliated STA. The use of this field can be, for example, to deal with reception of duplicate frames indicating PS state changes or out-of-order delivery of PS state change indications. For example, when a recipient MLD receives a cross-link PS state indication for a STA1 affiliated with a transmitting MLD, the same shall be applied to STA1 if the sequence number is higher than the sequence number received previously for STA1. When the sequence numbers become large, appropriate changes in rules may be used to deal with wrap-around of the counter.
TSF indication: This can be a field indicating the time at which the transmitting MLD generated the cross-link MLPS indication. The value can be in-terms of the TSF clock of the link where the frame is transmitted or can be based on the TSF clock of a reference link that is predetermined. The use of this field can be, for example, to deal with duplicate and out-of-order delivery of cross-link indications. In some embodiments, a subset of the bits of the TSF count are indicated.

In one example embodiment the above information can be carried in a new A-control field included by the transmitting MLD in a QoS frame. In the case where the transmitted frame is a control frame is a PS-poll frame, the frame can be included in a control-wrapper so that it can include an A-control field. In another example, the above indications can be carried in a new Action frame. For convenience, such a frame is referred to herein as MLPS Notification frame. In one variant, the MLPS Notification and MLPM Notification may share the same common frame with the Subtype field being used to distinguish between the purpose of the notification.

### Validating the MLPM/MLPS Notification:

An MLPM or MLPS Notification frame scheduled for delivery on a link may wait for a long time on the transmit queue before delivery. Within this time, if another STA sends an updated MLPM or MLPS Notification or a direct PM bit indication that differs from the queued notification, then an out-of-order delivery issue may happen. This can cause packet failures or RACE conditions where both the AP and the associated STA have a different view of the STAs power management or power save state. To prevent this, one or more steps may be taken by the transmitting MLD including:
Controlling the transmit time of the MLPM/MLPS notification: Restrictions may be imposed on the transmission of MLPM or MLPS frames. For example, in some embodiments, a minimum interval may be ensured between two indications of change in the power management mode or power save state indication. This minimum time can be implementation dependent, specified by the standard or can be indicated by the AP MLD. In another embodiment, it may be ensured that no MLPM or MLPS that contain a signaling for a specific STA are scheduled for transmission while another previous MLPM or MLPS that contains a different signaling for that specific STA is in the transmit buffer at any STA affiliated with the transmitting MLD, i.e., it has not been successfully delivered or been discarded.
Performing a check of the sequence number or TSF indication: Validation checks may be performed on the sequence number of TSF number indicated by the notification frame. For example, in some embodiments, the sequence number of TSF indication carried in the MLPM/MLPS notification may be checked to determine if the received MLPM/MLPS is out-of-order or not. For example, if a previous MLPM/MLPS has been received that carried an indication for a STA with a higher sequence number or TSF indication previously, then the new MLPM/MLPS indications may be ignored for that STA.
Restricting the use of conventional PM indication and PS state trigger frames: Restrictions may be applied on the conventional PM bit indication and the transmission of PS polls or U-APSD trigger frames, For example, in some embodiments, it may be ensured that no PS poll frames or U-APSD Trigger frames or frames that indicate a change in PM mode may be transmitted by a STA while another previous MLPM or MLPS that contains a different signaling for that specific STA is in the transmit buffer at any STA affiliated with the transmitting MLD, i.e., it has not been successfully delivered or been discarded.
Controlling the change of PM mode or PS state: Restrictions may be applied to when the STAs affiliated with the transmitting MLD can undergo PM mode or PS state changes. For example, in some embodiments, it may be ensured that the PM mode or PS state of a STA are not changed while an MLPM or MLPS that contains a signaling for that specific STA is in the transmit buffer at any STA affiliated with the transmitting MLD, i.e., it has not been successfully delivered or been discarded.
   Behavior after MLPM Notification:

In some embodiments, the transmitting MLD may ensure that the STA indicated transitioning to active mode in the MLPM indication should transition to active mode within an MLPM Delay duration of transmission of the MLPM indication. In another variant, the transmitting MLD may ensure that the STA indicated as transitioning to active mode in the MLPM indication should transition to active mode before the transmission of the MLPM indication (or at the scheduled start time of the mode change if applicable). In some embodiments, the transmitting MLD may ensure that the STA indicated as transitioning to power save mode should transition to doze state no earlier than an MLPM Delay duration after the successful transmission of the MLPM indication. In another embodiment, where MLPM Delay is not indicated by the receiving MLD, the transmitting MLD may wait a predetermined fixed value of time after the successful MLPM Notification, before transitioning to doze state.

When an AP affiliated with an AP MLD receives a valid MLPM indication from a non-AP MLD, it may share the information with other AP(s) operating on the link(s) for which a change in PM mode is indicated in the MLPM indication. For the links indicated to be transitioning to power save mode, the other AP(s) may start buffering traffic for the STA(s) affiliated with the non-AP MLD operating on that link, within a duration indicated in the MLPM Delay subfield after receipt of the MLPM indication. For the links indicated to be transitioning to active mode, the other AP(s) may stop buffering traffic and may schedule for transmission any buffered traffic for the STA(s) affiliated with the non-AP MLD operating on that link, at least a duration indicated in the MLPM Delay subfield after receipt of the MLPM Notification frame or after the start time indicated in the MLPM notification frame (as applicable).

Behavior after MLPS Notification:

In some embodiments, the transmitting MLD may ensure that the STA indicated transitioning to awake state in the MLPS indication should transition to awake state within an MLPS Delay duration of transmission of the MLPS indication. In another variant, the transmitting MLD may ensure that the STA indicated as transitioning to awake state in the MLPS indication should transition to awake state before the transmission of the MLPS indication (or at the scheduled start time of the state change if applicable).

When an AP affiliated with an AP MLD receives a valid MLPS indication from a non-AP MLD, it may share the information with other AP(s) operating on the link(s) for which a change in PS state change is indicated in the MLPS indication. For the links indicated to be transitioning to awake state, the other AP(s) may stop buffering traffic and may schedule for transmission any buffered traffic for the STA(s) affiliated with the non-AP MLD operating on that link, at least a duration indicated in the MLPS Delay subfield after the receipt of the MLPS Notification frame or after the start time indicated in the MLPS notification frame (as applicable).

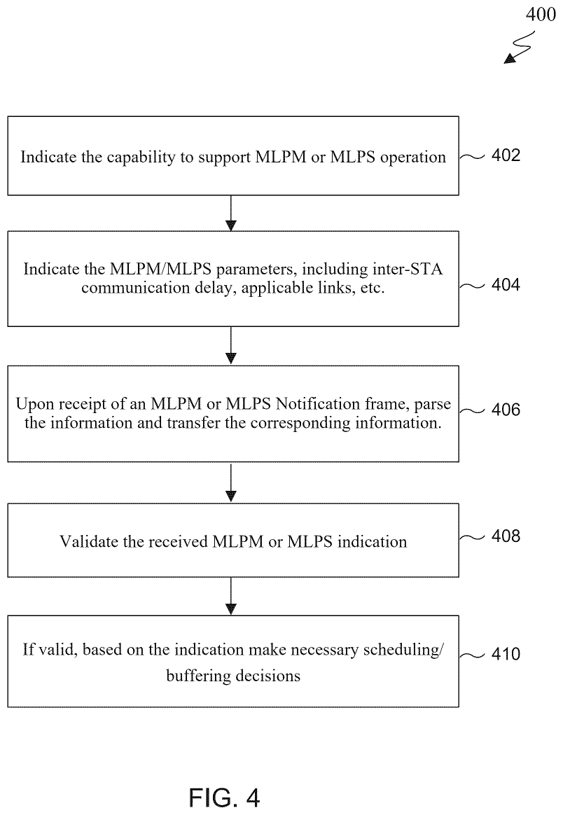

FIG. 4 illustrates an example flow diagram of an operation 400 performed by a receiving STA for transmission of cross-link power management mode transition or cross-link power save state transition according to embodiments of the present disclosure. For example, the operation 400 performed by a receiving STA for transmission of cross-link power management mode transition or cross-link power save state transition can be performed by any of the STAs 111-114 of FIG. 1. The embodiment of the operation 400 performed by a receiving STA for transmission of cross-link power management mode transition or cross-link power save state transition shown in FIG. 4 is for illustration only. Other embodiments of the example operation 400 performed by a receiving STA for transmission of cross-link power management mode transition or cross-link power save state transition could be used without departing from the scope of this disclosure.

As illustrated in FIG. 4, the operation 400 begins at step 402, where the STA can indicate the capability to support MLPM of MLPS operation. At step 404, the STA can indicate the MLPM/MLPS parameters, including inter-STA communication delay, applicable links, etc. At step 406, the STA, upon receipt of an MLPM or MLPS notification frame, can parse the information and transfer the corresponding information. At step 408, the STA can validate the received MLPM or MLPS indication. At step 410, the STA, based on the indication if valid, can make necessary scheduling/buffering decision.

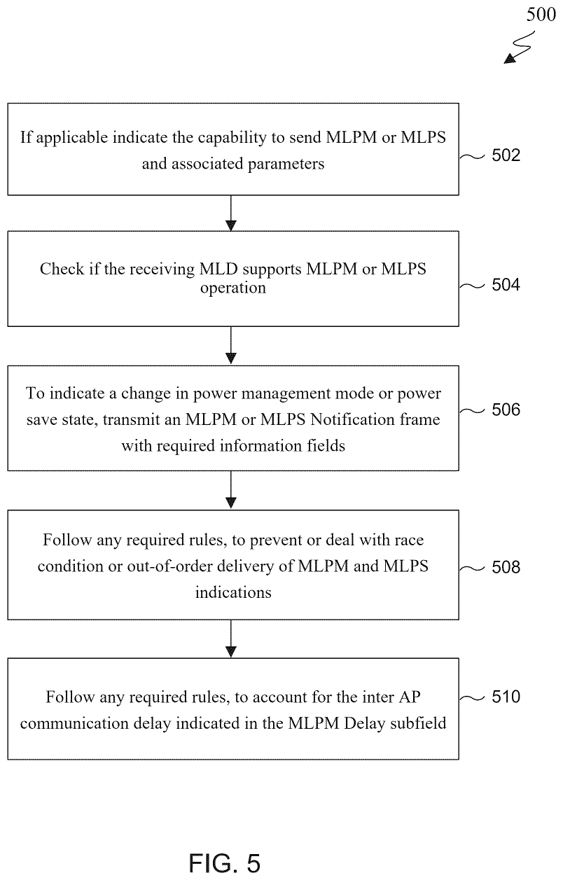

FIG. 5 illustrates an example flow diagram of an operation 500 performed by a transmitting STA for transmission of cross-link power management mode transition or cross-link power save state transition according to embodiments of the present disclosure. For example, the operation 500 performed by a transmitting STA for transmission of cross-link power management mode transition or cross-link power save state transition can be performed by any of the STAs 111-114 of FIG. 1. The embodiment of the operation 500 performed by a transmitting STA for transmission of cross-link power management mode transition or cross-link power save state transition shown in FIG. 5 is for illustration only. Other embodiments of the example operation 500 performed by a transmitting STA for transmission of cross-link power management mode transition or cross-link power save state transition could be used without departing from the scope of this disclosure.

As illustrated in FIG. 5, the operation 500 begins at step 502, where the STA can indicate the capability to send MLPM or MLPS and associated parameters. At step 504, the STA can check if the receiving MLD supports MLPM or MLPS operation. At step 506, the STA, to indicate a change in power management mode or power save state, can transmit an MLPM or MLPS notification frame with required information fields. At step 508, the STA can make sure to follow any required rules, to prevent or deal with race condition or out-of-order delivery of MLPM and MLPS indications. At step 510, the STA can make sure to follow any required rules, to account for the inter-AP communication delay indicated in the MLPM delay subfield.

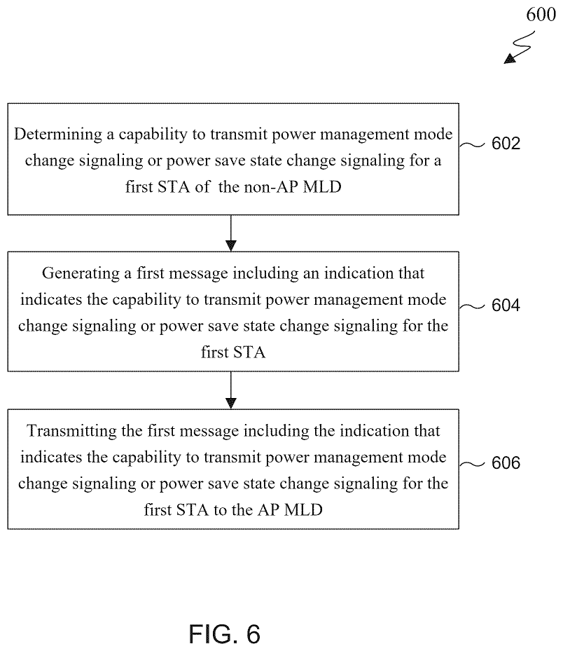

FIG. 6 illustrates an example method 600 performed by a non-AP MLD in a wireless communication system according to embodiments of the present disclosure. The method 600 of FIG. 6 can be performed by any of the STAs 111-114 of FIG. 1, such as the STA 111 of FIG. 3. The method 600 is for illustration only and other embodiments can be used without departing from the scope of the present disclosure. The non-AP MLD comprises STAs, each STA configured to transmit and receive information on a respective link established with a corresponding AP of an AP MLD.

As illustrated in FIG. 6, the method 600 begins at step 602, where the non-AP MLD determines a capability to transmit power management mode change signaling or power save state change signaling for a first STA of the non-AP MLD. At step 604, the non-AP MLD generates a first message including an indication that indicates the capability to transmit power management mode change signaling or power save state change signaling for the first STA. At step 606, the non-AP MLD transmits the first message including the indication that indicates the capability to transmit power management mode change signaling or power save state change signaling for the first STA to the AP MLD.

In some embodiments, the power management mode change is a change from power save mode to active mode or a change from active mode to power save mode, and the power save state change is a change from doze state to awake state or a change from awake state to doze state.

In some embodiments, the non-AP MLD receives a message from the AP MLD that contains at least one of: an indication of whether the AP MLD supports reception of power management mode change signaling or power save state change signaling for at least one STA of the non-AP MLD; an indication of affiliated links of the AP MLD on which the AP MLD supports reception of the power management mode change signaling or the power save state change signaling; and an indication of the affiliated link of the AP MLD whose time synchronization function (TSF) may be used as a reference from the power management mode change signaling or the power save state change signaling.

In some embodiments, the non-AP MLD determines a power management mode change or a power save state change for at least one STA of the non-AP MLD and transmits a second message to the AP MLD containing at least one of: an indication that indicates whether the second message conveys the power management mode change or the power save state change, an indication of the power management mode change or the power save state change for at least one STA of the non-AP MLD; an indication of links for which the power management mode change or the power save state change is applicable; an indication of a start time when the power management mode change or the power save state change is applicable; and an indication of a duration, as measured from an applicable start time, for which the power management mode change or the power save state change is applicable.

In some embodiments, the non-AP MLD receives delay information from the AP MLD that indicates an amount of time to process power management mode change indication or power save state change indication at the AP MLD; and changes a power management mode or a power save state for at least one STA of the non-AP MLD at a time determined based on the amount of time indicated by the delay information.

In some embodiments, the non-AP MLD minimizes or reduces the chance of out-of-order delivery or transmitting information to help detect and correct out-of-order delivery of the second message by following at least one of: controlling a transmit time of the second message; controlling the time of performing power management mode change or power save state change; including a value of the time synchronization function (TSF) of at least one link at the time of generating the second message, in the second message; including a sequence number within the second message to indicate the order of generation of the second message within a plurality of such second messages generated by the non-AP MLD; and restricting use of power management indication and power save state trigger frames.

In some embodiments, the first message is carried in a control field of a frame with the control identifier of the control field indicating that the message conveys power management mode change signaling or power save state change signaling.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A non-access point multi-link device (non-AP MLD), comprising:
stations (STAs), each STA comprising a transceiver configured to transmit and receive information on a respective link established with a corresponding access point (AP) of an access point multi-link device (AP MLD); and
a processor operably coupled with the STAs, the processor configured to:
determine a capability to transmit power management mode change signaling or power save state change signaling for a first STA of the non-AP MLD;
generate a first message including an indication that indicates the capability to transmit power management mode change signaling or power save state change signaling for the first STA; and
transmit, via a first transceiver of the first STA, the first message including the indication that indicates the capability to transmit power management mode change signaling or power save state change signaling for the first STA to the AP MLD.

2. The non-AP MLD of claim 1, wherein the power management mode change is a change from power save mode to active mode or a change from active mode to power save mode, and the power save state change is a change from doze state to awake state or a change from awake state to doze state.

3. The non-AP MLD of claim 1, wherein the processor is further configured to support reception of a message from the AP MLD that contains at least one of:
an indication of whether the AP MLD supports reception of power management mode change signaling or power save state change signaling for at least one STA of the non-AP MLD;
an indication of affiliated links of the AP MLD on which the AP MLD supports reception of the power management mode change signaling or the power save state change signaling; and
an indication of an affiliated link of the AP MLD whose time synchronization function (TSF) may be used as a reference from the power management mode change signaling or the power save state change signaling.

4. The non-AP MLD of claim 1, wherein the processor is further configured to:
determine a power management mode change or a power save state change for at least one STA of the non-AP MLD and transmit a second message to the AP MLD containing at least one of:
an indication that indicates whether the second message conveys the power management mode change or the power save state change,
an indication of the power management mode change or the power save state change for at least one STA of the non-AP MLD;
an indication of links for which the power management mode change or the power save state change is applicable;
an indication of a start time when the power management mode change or the power save state change is applicable; and
an indication of a duration, as measured from an applicable start time, for which the power management mode change or the power save state change is applicable.

5. The non-AP MLD of claim 1, wherein the processor is further configured to:
receive delay information from the AP MLD that indicates an amount of time to process power management mode change indication or power save state change indication at the AP MLD; and
change a power management mode or a power save state for at least one STA of the non-AP MLD at a time determined based on the amount of time indicated by the delay information.

6. The non-AP MLD of claim 4, wherein the processor is further configured to:
reduce a chance of out-of-order delivery or transmit information to help detect and correct out-of-order delivery of the second message by following at least one of:
controlling a transmit time of the second message;
controlling a time of performing power management mode change or power save state change;
including a value of a time synchronization function (TSF) of at least one link at a time of generating the second message, in the second message;
including a sequence number within the second message to indicate an order of generation of the second message within a plurality of such second messages generated by the non-AP MLD; and
restricting use of power management indication and power save state trigger frames.

7. The non-AP MLD of claim 1, wherein the first message is carried in a control field of a frame with a control identifier of the control field indicating that the first message conveys power management mode change signaling or power save state change signaling.

8. An access point multi-link device (AP-MLD), comprising:
access points (APs), each AP comprising a transceiver configured to transmit and receive information on a respective link established with a corresponding station (STA) of a non-access point multi-link device (non-AP MLD); and
a processor operably coupled with the APs, the processor configured to:
determine a capability to transmit power management mode change signaling or power save state change signaling for a first AP of the AP MLD;
generate a first message including an indication that indicates the capability to transmit power management mode change signaling or power save state change signaling for the first AP; and
transmit, via a first transceiver of the first AP, the first message including the indication that indicates the capability to transmit power management mode change signaling or power save state change signaling for the first AP to the non-AP MLD.

9. The AP-MLD of claim 8, wherein the power management mode change is a change from power save mode to active mode or a change from active mode to power save mode, and the power save state change is a change from doze state to awake state or a change from awake state to doze state.

10. The AP MLD of claim 8, wherein the processor is further configured to support transmission of a second message that contains at least one of:
an indication of whether the AP MLD supports reception of power management mode change signaling or power save state change signaling for at least one STA of the non-AP MLD;
an indication of affiliated links of the AP MLD on which it supports reception of the power management mode change signaling or power save state signaling; and
an indication of an affiliated link of the AP MLD whose time synchronization function (TSF) may be used as a reference from the change signaling.

11. The AP MLD of claim 8, wherein the processor is further configured to:
receive, from the non-AP MLD, a third message associated with a determined power management mode change or a power save state change for at least one STA of the non-AP MLD; and
reduce a chance of out-of-order delivery or receive information to help detect and correct out-of-order delivery of a message by following at least one of:
performing a check of a value of a time synchronization function (TSF) of at least one link received in the message from the non-AP MLD; and
performing a check of a sequence number within the message to indicate an order of generation of the message within a plurality of such received messages generated by the non-AP MLD.

12. The AP MLD of claim 8, wherein when the first AP receives an indication of a valid power management mode change or a valid power save state change from the non-AP MLD, the processor is further configured to:
share information with other APs operating on links for which the power management mode change or the power save state change is indicated.

13. The AP MLD of claim 8, wherein when the first AP receives an indication of a valid power management mode change or a valid power save state change from the non-AP MLD, the processor is further configured to:
transmit delay information that indicates an amount of time to process power management mode change indication or power save state change indication at the AP MLD; and
enable the non-AP MLD to change a power management mode or a power save state for at least one STA of the non-AP MLD at a time determined based on the amount of time indicated by the delay information.

14. A method for operating a non-access point multi-link device (non-AP MLD), the non-AP MLD comprising stations (STAs), each STA configured to transmit and receive information on a respective link established with a corresponding access point (AP) of an access point multi-link device (AP MLD), the method comprising:
determining a capability to transmit power management mode change signaling or power save state change signaling for a first STA of the non-AP MLD;
generating a first message including an indication that indicates the capability to transmit power management mode change signaling or power save state change signaling for the first STA; and
transmitting the first message including the indication that indicates the capability to transmit power management mode change signaling or power save state change signaling for the first STA to the AP MLD.

15. The method of claim 14, wherein the power management mode change is a change from power save mode to active mode or a change from active mode to power save mode, and the power save state change is a change from doze state to awake state or a change from awake state to doze state.

16. The method of claim 14, further comprising:
receiving a message from the AP MLD that contains at least one of:
an indication of whether the AP MLD supports reception of power management mode change signaling or power save state change signaling for at least one STA of the non-AP MLD;
an indication of affiliated links of the AP MLD on which the AP MLD supports reception of the power management mode change signaling or the power save state change signaling; and
an indication of an affiliated link of the AP MLD whose time synchronization function (TSF) may be used as a reference from the power management mode change signaling or the power save state change signaling.

17. The method of claim 14, further comprising:
determining a power management mode change or a power save state change for at least one STA of the non-AP MLD and transmitting a second message to the AP MLD containing at least one of:
an indication that indicates whether the second message conveys the power management mode change or the power save state change,
an indication of the power management mode change or the power save state change for at least one STA of the non-AP MLD;
an indication of links for which the power management mode change or the power save state change is applicable;
an indication of a start time when the power management mode change or the power save state change is applicable; and
an indication of a duration, as measured from an applicable start time, for which the power management mode change or the power save state change is applicable.

18. The method of claim 14, further comprising:
receiving delay information from the AP MLD that indicates an amount of time to process power management mode change indication or power save state change indication at the AP MLD; and
changing a power management mode or a power save state for at least one STA of the non-AP MLD at a time determined based on the amount of time indicated by the delay information.

19. The method of claim 17, further comprising:
reducing a chance of out-of-order delivery or transmitting information to help detect and correct out-of-order delivery of the second message by following at least one of:
controlling a transmit time of the second message;
controlling a time of performing power management mode change or power save state change;
including a value of a time synchronization function (TSF) of at least one link at a time of generating the second message, in the second message;
including a sequence number within the second message to indicate an order of generation of the second message within a plurality of such second messages generated by the non-AP MLD; and
restricting use of power management indication and power save state trigger frames.

20. The method of claim 14, wherein the first message is carried in a control field of a frame with a control identifier of the control field indicating that the first message conveys power management mode change signaling or power save state change signaling.
